(19) United States
(12) Patent Application Publication
(10) Pub. No.: US 2014/0375153 A1
(43) Pub. Date: Dec. 25, 2014

(54) ROTATING ELECTRIC MACHINE FOR VEHICLES

(71) Applicant: DENSO CORPORATION, Kariya-city (JP)

(72) Inventor: Takuto SUZUKI, Okazaki-shi (JP)

(21) Appl. No.: 14/304,343

(22) Filed: Jun. 13, 2014

(30) Foreign Application Priority Data
Jun. 24, 2013 (JP) 2013-131629

(51) Int. Cl. H02K 11/00; H02K 9/19

(52) U.S. Cl. CPC H02K 11/0073; H02K 9/19
USPC 310/54; 310/71

(57) ABSTRACT

A rotating electric machine for vehicles has a rotor, a stator, and an electric power converter. The electric power converter has a plurality of MOS modules including a MOS transistor on a high side and another MOS transistor on a low side. Each of the MOS modules has a length and a plurality of terminals are pulled out from both ends of the switching module, the plurality of terminals are disposed in positions where currents that flow through insides of the modules are faced to each other in opposite flowing direction, and bus bars are disposed at upper surface side of each module.

### CROSS-REFERENCE TO RELATED APPLICATION

This application is based on and claims the benefit of priority from earlier Japanese Patent Application No. 2013-131629 filed Jun. 24, 2013, the description of which is incorporated herein by reference.

### TECHNICAL FIELD

The present disclosure relates to a rotating electric machine for vehicles installed in a passenger car, a truck, and the like.

### BACKGROUND

Conventionally, a unified alternator-starter having a control power module in which a driver circuit in a control unit is disposed as close as possible to a power transistor in a power unit is known (refer to Japanese Patent No. 4369991, for example).

Fixation of the power module included in the alternator-starter is performed by screwing the power module to a radiator in two places, for example.

Since the power module disclosed in the above-mentioned Document '991 is fixed by screwing it to the radiator in two places, for example, the outer shape including these fixing places becomes large and there is a problem that minimizing a mounting area is difficult.

In addition, although a power module that is not fixed by screwing is also disclosed in the Document '991, a fixing method replacing it is needed for the alternator-starter directly mounted on an engine block.

For example, although it is possible to use adhesives for fixation, it is not a desirable fixing method because a thermal conductivity between the engine block and the radiator worsens.

Moreover, the power module includes two high side power transistors (MOS transistor) and two low side power transistors (MOS transistor).

No measure is taken in particular about inductance of connecting wires that connect between these power transistors and in-vehicle power supply networks or grounding wires, or about inductance including the in-vehicle power supply networks or the grounding wires.

For this reason, there are problems that the inductances of these wirings are comparatively large, a surge voltage that occurs when operating the alternator-starter as a starter (motor) and turning a power transistor on and off by PWM control becomes large, and heat generation is large.

### SUMMARY

An embodiment provides a rotating electric machine for vehicles that can reduce a surge voltage that occurs when turning a MOS transistor on and off and heat generation accompanying this occurrence, and can miniaturize a module for minimizing a mounting area.

In a rotating electric machine for vehicles according to a first aspect, the rotating electric machine includes a rotor, a stator disposed facing the rotor, and an electric power converter that converts alternating current voltage induced by a stator winding included in the stator into direct current voltage, or converts direct current voltage applied from outside into alternating current voltage and applies it to the stator winding.

The electric power converter includes a plurality of switching modules, each of which includes a first switching element on a high side and a second switching element on a low side.

The switching module has a length and a plurality of terminals which are pulled out from both ends of the switching module, the plurality of terminals are disposed in positions where currents that flow through insides of the switching modules are faced to each other in opposite flowing directions, and a bus bar is disposed at an upper surface side of each switching module.

Since the terminals are disposed so that the currents that flow through the switching modules flow in opposite directions, the magnetic fields that occur around the current pathways can be mutually canceled, and inductance of the current pathways inside the switching modules can be reduced.

Thereby, surge voltage generated when turning on and off the switching modules and heat generated accompanying the occurrence can be reduced.

In the rotating electric machine for vehicles according to a second aspect, the bus bar is attached to the switching module in a condition where each upper surface of the switching modules is pressed.

In the rotating electric machine for vehicles according to a third aspect, the electric power converter has a terminal base to which the bus bar is inserted.

In the rotating electric machine for vehicles according to a fourth aspect, grease is filled in gaps formed between the switching modules and the terminal base.

In the rotating electric machine for vehicles according to a fifth aspect, the bus bar is formed by laminating tabular wiring layers, the plurality of terminals pulled out from both ends of the switching module are a ground terminal and a power supply terminal, and the wiring layers are connected to the ground terminal and the power supply terminal.

In the rotating electric machine for vehicles according to a sixth aspect, the switching module has a rectangular shape, the terminals are disposed in one of two facing sides of the switching module, and another terminal connected to the stator winding is disposed in another one of the two facing sides.

In the rotating electric machine for vehicles according to a seventh aspect, a frame that accommodates the rotor and the stator is disposed on the switching module opposite from the side where pressure is being applied from, and a bottom surface of the switching module contacts the frame.

In the rotating electric machine for vehicles according to an eighth aspect, grease is filled in gaps formed between the switching modules and the frame.

In the rotating electric machine for vehicles according to a ninth aspect, the frame has a cooling fluid channel, and is cooled by a cooling fluid that flows through the cooling fluid channel.

In the rotating electric machine for vehicles according to a tenth aspect, the bus bar is used as a heat dissipation member that radiates heat generated by the first and second switching elements included in the switching modules.

### BRIEF DESCRIPTION OF THE DRAWINGS

In the accompanying drawings:

FIG. 1 shows a composition of a rotating electric machine for vehicles of an embodiment;

FIG. 2 shows a composition of a MOS module;

FIG. 3 shows a composition of an H-bridge circuit;

FIG. 4 shows a specific example of disposition of a rotation angle sensor;

FIG. 5 shows a perspective view of the rotating electric machine for vehicles including an electric power converter;

FIG. 6 shows an exploded perspective view of the electric power converter;

FIG. 7 shows an outline shape of a positive electrode side input/output terminal and a negative electrode side input/output terminal;

FIG. 8 shows a plan view of the electric power converter when mounted;

FIG. 9 shows a mounting state of inside a MOS module; and

FIG. 10 shows a partial sectional view of a frame.

### DETAILED DESCRIPTION OF THE PREFERABLE EMBODIMENTS

With reference to the accompanying drawings, hereinafter will be described an embodiment of the present disclosure.

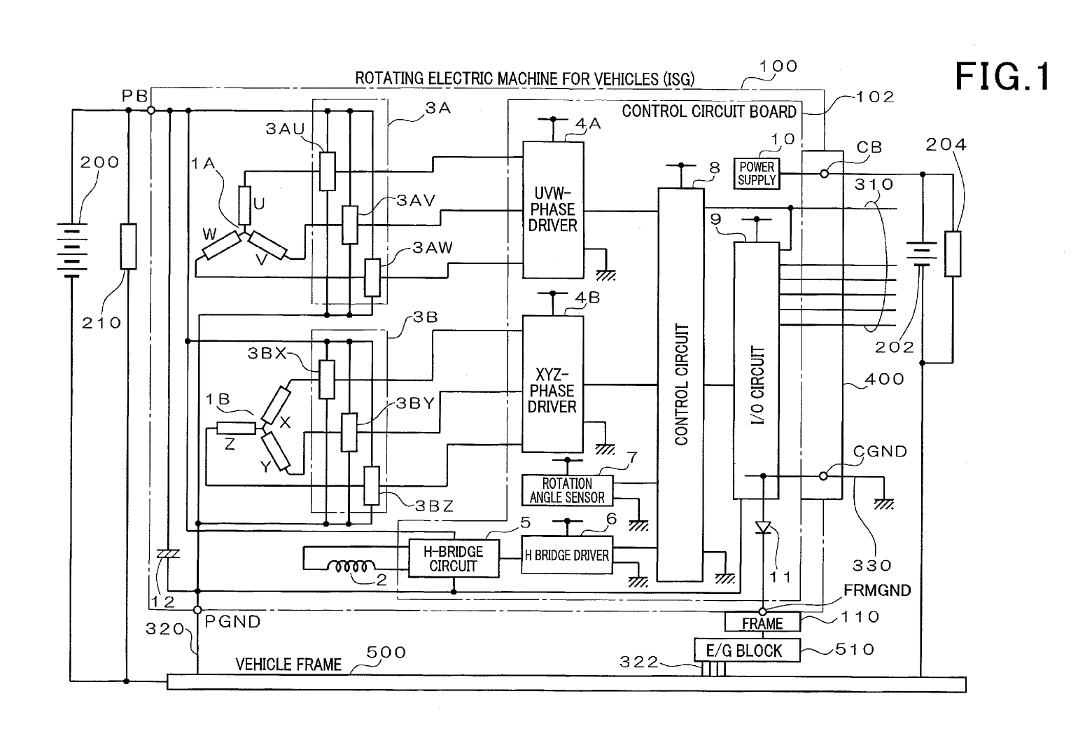

As shown in FIG. 1, a rotating electric machine 100 for vehicles of an embodiment is constituted including two stator windings 1A and 1B, a field winding 2, two MOS module groups 3A and 3B, a UVW-phase driver 4A, an XYZ-phase driver 4B, an H-bridge circuit 5, an H bridge driver 6, a rotation angle sensor 7, a control circuit 8, an input/output circuit 9, a power supply circuit 10, a diode 11, and a capacitor 12.

The present rotating electric machine 100 is called an ISG (integrated starter generator), and has functions of both an electric motor and a generator.

One of the stator windings 1A is a three-phase winding composed of a U-phase winding, a V-phase winding, and a W-phase winding, and is wound around a stator core (not shown).

Similarly, another one of the stator windings 1B is a three-phase winding composed of an X-phase winding, a Y-phase winding, and a Z-phase winding, and is wound around the stator core mentioned above in a position shifted 30 degrees in electric angle relative to the stator winding 1A.

A stator is constituted by these two stator windings 1A and 1B and the stator core in the present embodiment.

It should be noted that number of phases for each stator winding 1A and 1B may be other than three.

The field winding 2 is for making a rotor, which has a rotational shaft that inputs and outputs a driving force between an engine via a belt or a gear, generates a magnetic field, and is wound around a field pole (not shown) to constitute the rotor.

One of the MOS module groups 3A is connected to one of the stator windings 1A, and a three-phase bridge circuit is constituted by the whole group.

This MOS module group 3A operates as an electric power converter 3 that converts alternating current voltage induced by the stator winding 1A during a power generation into direct current voltage, and converts direct current voltage applied from outside (high-voltage battery 200) into alternating current voltage and applies thereof to the stator winding 1A during operation as an electric motor.

The MOS module group 3A has three MOS modules 3AU, 3AV, and 3AW corresponding to the number of the phases of the stator winding 1A.

The MOS module 3AU is connected to the U-phase winding included in the stator winding 1A. The MOS module 3AV is connected to the V-phase winding included in the stator winding 1A. The MOS module 3AW is connected to the W-phase winding included in the stator winding 1A.

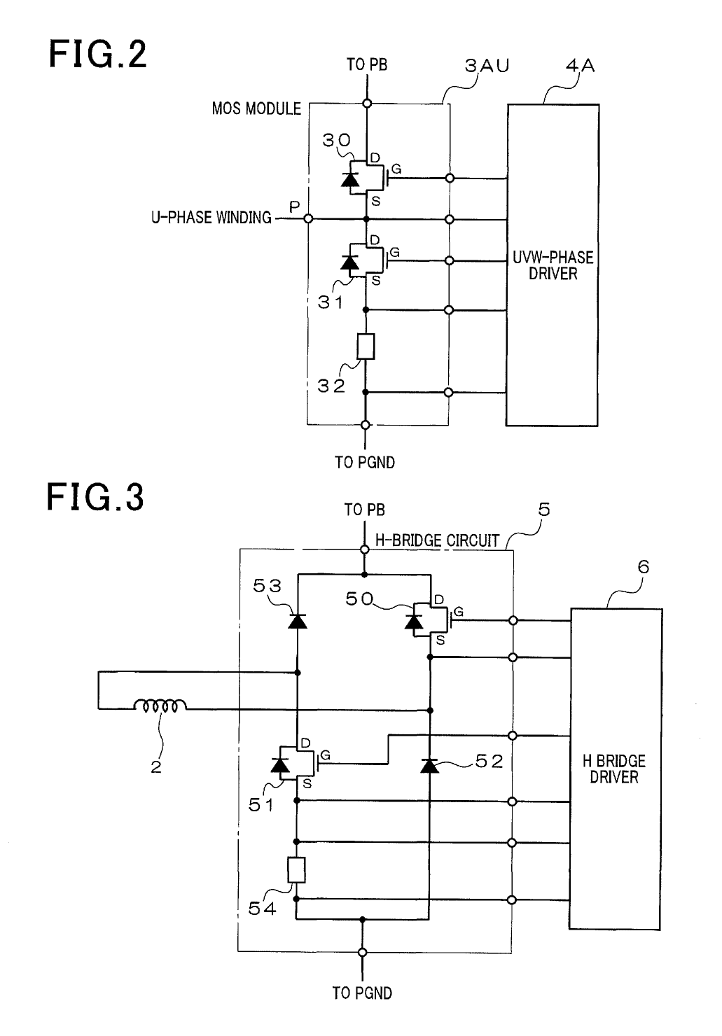

As shown in FIG. 2, the MOS module 3AU has two MOS transistors 30 and 31 and a current detection resistor 32.

One of the MOS transistors 30 is a first switching element of an upper arm (high side) in which a source is connected to the U-phase winding of the stator winding 1A via a P terminal, and a drain is connected to a power supply terminal PB.

The power supply terminal PB is connected to a positive terminal of the high-voltage battery 200 (a first battery) with the rating of 48V, or a high-voltage load 210, for example.

Another one of the MOS transistor 31 is a second switching element of a lower arm (low side) in which a drain is connected to the U-phase winding via a P terminal, and a source is connected to a power ground terminal PGND through the current detection resistor 32.

A series circuit of the two MOS transistors 30 and 31 is disposed between the positive terminal and a negative terminal of the high-voltage battery 200, and the U-phase winding is connected to the connection point of the two MOS transistors 30 and 31 through a P terminal.

Moreover, a gate and a source of the MOS transistor 30, a gate of the MOS transistor 31, and both ends of the current detection resistor 32 are connected to the UVW-phase driver 4A.

A diode is connected in parallel between the source and the drain of each MOS transistor 30 and 31.

Although the diode is realized by a parasitic diode (body diode) of the MOS transistors 30 and 31, the diode may be further prepared as another component and connected in parallel.

In addition, at least either one of the upper arm and the lower may be constituted by a switching element other than the MOS transistor.

In addition, the MOS modules 3AV, 3AW and MOS modules 3BX, 3BY, and 3BZ mentioned later other than the MOS module 3AU fundamentally have the same composition as the MOS module 3AU, thus detailed explanation is omitted.

Another one of the MOS module groups 3B is connected to another one of the stator windings 1B, and a three-phase bridge circuit is constituted by the whole.

This MOS module group 3B operates as an electric power converter that converts alternating current voltage induced by the stator winding 1B during a power generation into direct current voltage, and converts direct current voltage applied from outside (high-voltage battery 200) into alternating current voltage and applies thereof to the stator winding 1B during operating as an electric motor.

The MOS module group 3B has three MOS modules 3BX, 3BY, and 3BZ as switching modules corresponding to the number of the phases of the stator winding 1B.

The MOS module 3BX is connected to the X-phase winding included in the stator winding 1B. The MOS module 3BY is connected to the Y-phase winding included in the stator winding 1B. The MOS module 3BZ is connected to the Z-phase winding included in the stator winding 1B.

The UVW-phase driver 4A generates a driving signal inputted into each gate of the MOS transistors 30 and 31 included in each of three MOS modules 3AU, 3AV, and 3AW, while detecting the potential difference across the current detection resistor 32.

Similarly, the XYZ-phase driver 4B generates a driving signal inputted into each gate of the MOS transistors 30 and 31 included in each of three MOS modules 3BX, 3BY, and 3BZ, while detects both-end voltage of the current detection resistor 32.

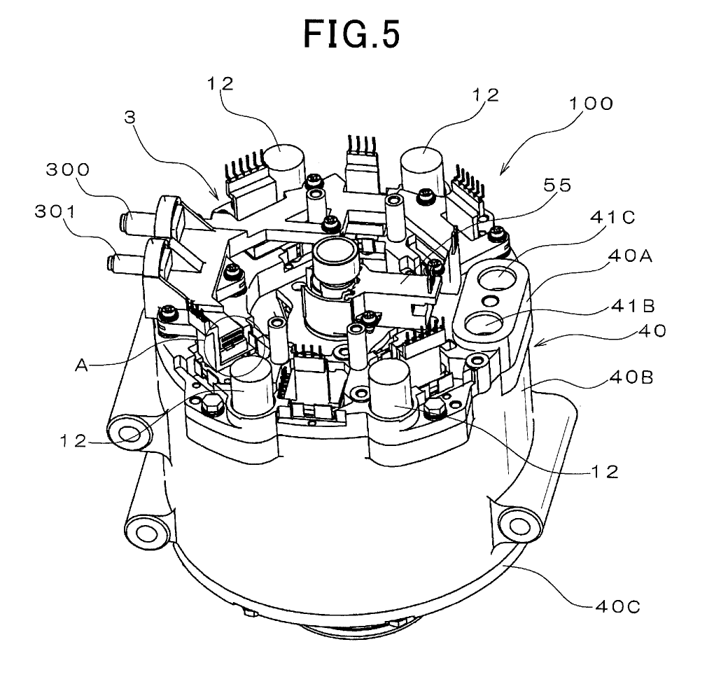

The H-bridge circuit 5 is connected to the both ends of the field winding 2 via a brush device 55 (refer to FIG. 5), and is a magnetization circuit that supplies exciting current to the field winding 2.

As shown in FIG. 3, the H-bridge circuit 5 has two MOS transistors 50 and 51, two diodes 52 and 53, and a current detection resistor 54.

The MOS transistor 50 on the high side and the diode 52 on the low side are connected in series, and one end of the field winding 2 is connected at this connection point.

Moreover, the diode 53 on the high side, the MOS transistor 51 on the low side, and the current detection resistor 54 are connected in series, and another end of the field winding 2 is connected at a connection point of the diode 53 and the MOS transistor 51.

This H-bridge circuit 5 is connected to both the power supply terminal PB and the power ground terminal PGND.

Exciting current is supplied to the field winding 2 from the H-bridge circuit 5 by turning on the MOS transistors 50 and 51.

Moreover, the supply of the exciting current is stopped by turning either one of the MOS transistors 50 and 51 off, while the exciting current that flows through the field winding 2 through either one of the diodes 52 and 53 can be returned.

The H bridge driver 6 generates a driving signal inputted into each gate of the MOS transistors 50 and 51 included in the H-bridge circuit 5, while detecting the potential difference across the current detection resistor 54.

The rotation angle sensor 7 detects a rotation angle of the rotor. The rotation angle sensor 7 can be constituted by using a permanent magnet and a Hall element (Hall Effect sensor), for example.

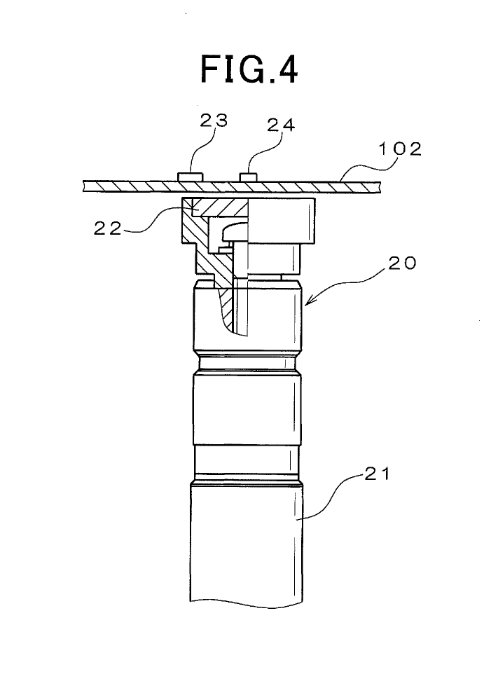

As specifically shown in FIG. 4, the permanent magnet 22 is fixed at a tip of a rotational shaft 21 of the rotor 20, while the Hall elements 23 and 24 are disposed in positions that face the permanent magnet 22 (disposed in the positions near a perimeter of the permanent magnet 22 and 90 degrees apart mutually, for example).

By taking out an output, the rotation angle of the rotor 20 that rotates with the permanent magnet 22 can be detected.

In addition, the rotation angle sensor 7 may be constituted without using the Hall elements 23 and 24.

Moreover, the disposition and the method of mounting of the permanent magnet 22 shown in FIG. 4 are just an example, and may be altered suitably according to the rotational shaft 21 or its surrounding structures.

The control circuit 8 controls the whole rotating electric machine 100. The control circuit 8 has an analog-digital converter and a digital-analog converter, and signals among other composition are inputted and outputted.

The control circuit 8 is constituted by a microcomputer, for example, and by running a predetermined control program, the UVW driver 4A, the XYZ driver 4B, and H bridge driver 6 are controlled so that the rotating electric machine 100 is operated as an electric motor or a generator, and various processing such as an abnormality detection, notification, etc. is performed.

The input/output circuit 9 inputs and outputs signals between outside via a controlling harness 310, level conversion of the terminal voltage of the high-voltage battery 200 or the voltage of the power ground terminal PGND, and the like.

The input/output circuit 9 is an input-output interface for processing the signals and voltage that are inputted and outputted, and required functions are realized by a custom IC, for example.

A low-voltage battery 202 (a second battery) with the rating of 12V is connected to the power supply circuit 10, and the power supply circuit 10 generates an operating voltage of 5V by, for example, turning a switching element on and off and smoothing an output thereof by a capacitor.

By the operating voltage, the UVW-phase driver 4A, the XYZ-phase driver 4B, the H bridge driver 6, the rotation angle sensor 7, the control circuit 8, and the input/output circuit 9 operate.

The capacitor 12 is for removing or reducing the switching noise that occurs when turning on and off such as the MOS transistors 30 and 31 of the MOS modules 3AU (hereafter, the MOS modules 3AU include 3AV, 3AW, 3BX, 3BY, and 3BZ) in order to operate the rotating electric machine 100 as the electric motor.

Although a single capacitor 12 is used in the example shown in FIG. 1, the number is determined suitably in actuality according to the size of the switching noise.

For example, as shown in FIG. 5, four capacitors 12 are used in the rotating electric machine 100 of the present embodiment.

The above-mentioned UVW-phase driver 4A, the XYZ-phase driver 4B, the H-bridge circuit 5, the H bridge driver 6, the rotation angle sensor 7 (except for the permanent magnet fixed to the rotor), the control circuit 8, the input/output circuit 9, and the power supply circuit 10 are mounted on a single control circuit board 102.

Moreover, as shown in FIG. 1, the rotating electric machine 100 has the power supply terminal PB and the power ground terminal PGND, as well as a connector 400 to which a control ground terminal CGND, a control source terminal CB, and the controlling harness 310, etc. are attached.

The power supply terminal PB is a positive side input/output terminal of the high voltage, and the high-voltage battery 200 and the high-voltage load 210 are connected through a predetermined cable.

The control source terminal CB is a positive side input terminal of the low voltage, and the low-voltage battery 202 and the low-voltage load 204 are connected through a predetermined cable.

The power ground terminal PGND is a first ground terminal as a negative electrode side input/output terminal, and is for grounding a power system circuit.

This power ground terminal PGND is connected to a vehicle frame 500 through a grounding harness 320 as a first connecting cable.

The MOS module groups 3A and 3B (electric power converter) and the H-bridge circuit 5 (magnetization circuit) mentioned above are the power system circuit.

The MOS transistors 30, 31, 50, and 51 as power elements where the same current as the stator windings 1A and 1B or the field winding 2 flows are included in the power system circuit.

Moreover, the control ground terminal CGND is a second ground terminal prepared independently for the power ground terminal PGND, and is for grounding a control system circuit.

This control ground terminal CGND is grounded through a grounding cable 330 (a second connecting cable) other than the grounding harness 320.

The diode 11 is inserted between the control ground terminal CGND and a frame of the rotating electric machine 100 (henceforth called the “ISG frame”) 110 through an internal wiring of the input/output circuit 9.

Specifically, a negative electrode of the diode 11 is connected to a frame ground terminal FRMGND, and the frame ground terminal FRMGND is connected to the ISG frame 110.

The above-mentioned UVW-phase driver 4A, the XYZ-phase driver 4B, the H bridge driver 6, the rotation angle sensor 7, the control circuit 8, the input/output circuit 9, etc. are the control system circuit.

In addition, a connection position of the grounding cable 330 is a position where a ground potential is 0V prepared in the vehicle side, and there shall be no voltage variation.

Moreover, although the diode 11 is disposed outside the input/output circuit 9 in FIG. 1, the diode 11 may be mounted in the input/output circuit 9.

The connector 400 is for attaching the controlling harness 310, the grounding cable 330, and other cables to terminals (the control ground terminal CGND, the control source terminal CB, etc.) other than the power supply terminal PB and the power ground terminal PGND.

The ISG frame 110 of the rotating electric machine 100 mentioned above is the conductor formed by aluminum die-casting, for example, and the ISG frame 110 is fixed to an engine (E/G) block 510 with bolts.

Furthermore, the engine block 510 is connected to the vehicle frame 500 by the grounding harness 322.

The rotating electric machine 100 for vehicles of the present embodiment has such composition as mentioned above, and the electric power converter 3 in this regard will be explained next.

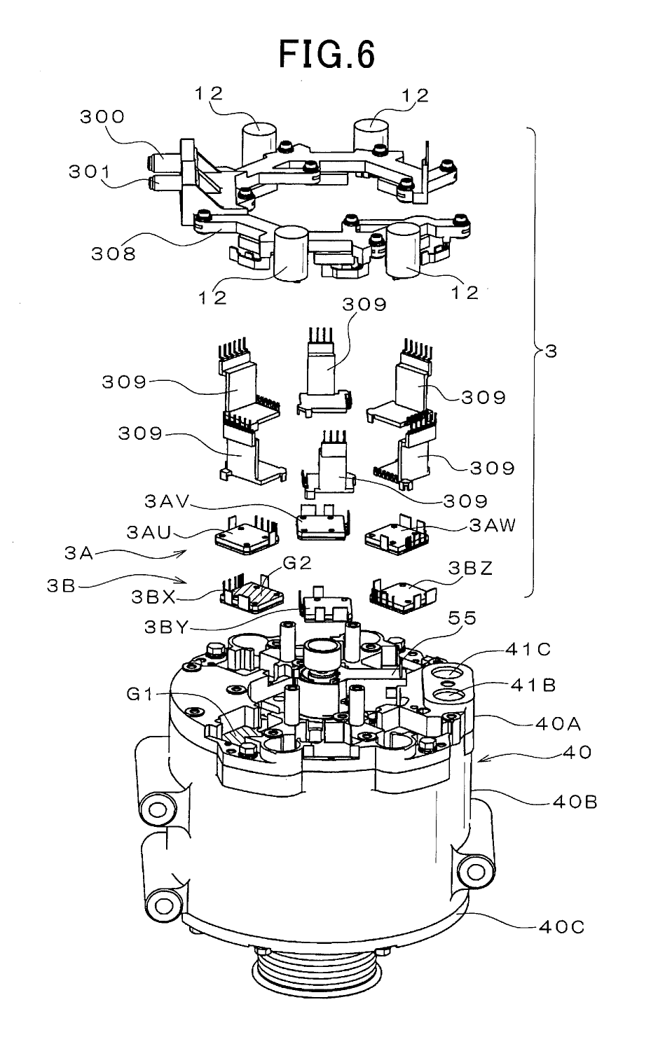

As shown in FIG. 6, the electric power converter 3 unitarily constituted by including the two MOS module groups 3A and 3B is by constituted including the MOS modules 3AU, 3AV, 3AW, 3BX, 3BY, 3BZ, a terminal base 308 where a positive electrode side input/output terminal 300 and a negative electrode side input/output terminal 301 are projected from, and six intermediate terminal bases 309 disposed between each MOS module 3AU and the terminal base 308.

The positive electrode side input/output terminal 300 and the negative electrode side input/output terminal 301 have different shape (bolts having different diameters, for example).

In addition, the control circuit board 102 where the control circuit 8 and the input/output circuit 9, etc. are mounted and the rotating electric machine 100 in which a rear cover that covers the electric power converter 3 and the control circuit board 102 is removed are shown in the exploded perspective view of the electric power converter 3 shown in FIG. 6 and the perspective view of the rotating electric machine 100 shown in FIG. 5.

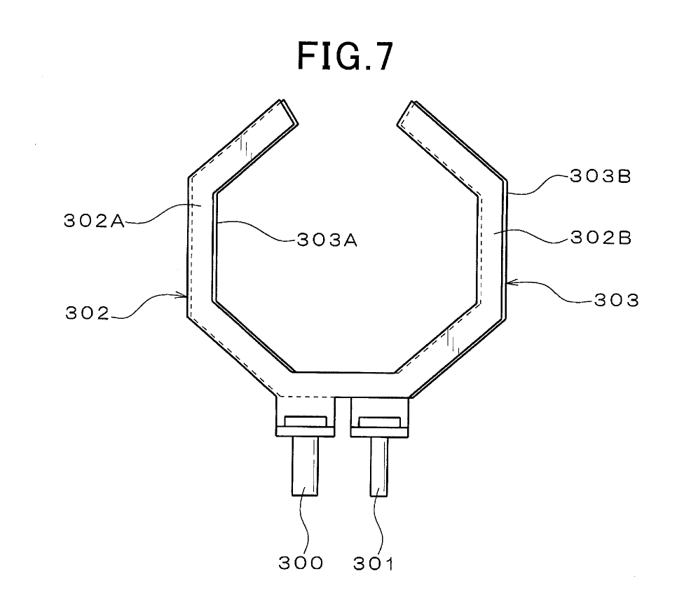

The terminal base 308 is formed by insert molding, and includes a positive electrode side bus bar 302 as a tabular wiring layer to which the positive electrode side input/output terminal 300 is connected, and a negative electrode side bus bar 303 as a tabular wiring layer to which the negative electrode side input/output terminal 301 is connected (refer to FIG. 7).

The positive electrode side bus bar 302 and the negative electrode side bus bar 303 are laminated facing each other sandwiching a resin material that constitutes the terminal base 308.

FIG. 5 shows a state in which a part of the terminal base 308 (FIG. 6) is broken out in the middle, and a state where the positive electrode side bus bar 302 (FIG. 7) and the negative electrode side bus bar 303 (FIG. 7) are exposed in a broken-out section is shown (A section).

Moreover, as shown in FIG. 7, the positive electrode side bus bar 302 has a pair of branch portions 302A and 302B extending in two directions sandwiching the positive electrode side input/output terminal 300 therebetween.

The two branch portions 302A and 302B have symmetrical shape (line symmetry) across a center of the positive electrode side input/output terminal 300 and the negative electrode side input/output terminal 301.

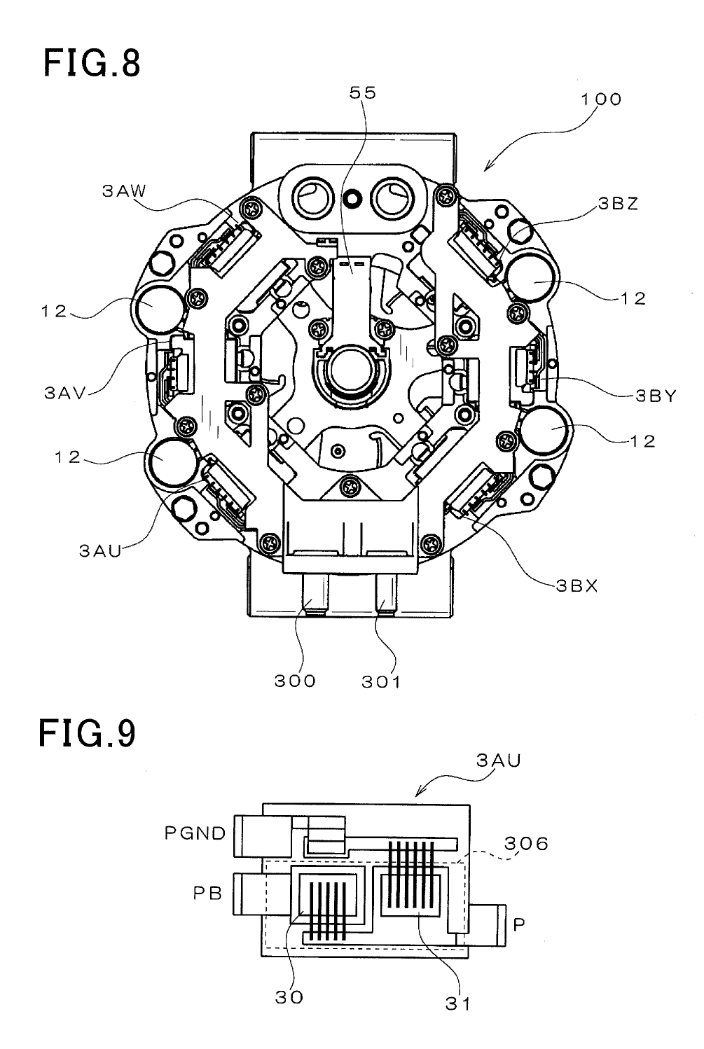

As shown in FIG. 8, each power supply terminal (power supply terminal PB) of the MOS modules 3AU, 3AV, and 3AW is connected to one of the branch portions 302A at substantially equal intervals.

Each power supply terminal PB of the MOS modules 3BX, 3BY, and 3BZ is connected to the other one of the branch portions 302B at substantially equal intervals.

Moreover, the negative electrode side bus bar 303 has a pair of branch portions 303A and 303B extending in two directions sandwiching the negative electrode side input/output terminal 301 therebetween.

The two branch portions 303A and 303B have symmetrical shape (line symmetry) across a center of the positive electrode side input/output terminal 300 and the negative electrode side input/output terminal 301.

Each ground terminal (power ground terminal PGND) of the MOS modules 3AU, 3AV, and 3AW is connected to one of the branch portions 303A at substantially equal intervals.

Each power supply terminal (power supply terminal PB) of the MOS modules 3BX, 3BY, and 3BZ is connected to the other one of the branch portions 303B at substantially equal intervals.

As shown in FIG. 9, in the MOS module 3AU (the same to other MOS modules 3AV, etc.), the power supply terminal PB, the P terminal, and the power ground terminal PGND are pulled out from both ends (from each of a short side of a rectangular shape that faces each other) of the case (for example, formed by a resin mold) having a rectangular shape.

Moreover, the power supply terminal PB, the P terminal, and the power ground terminal PGND are disposed in a position where a direction of the current that flows among them is turned around and faces each other.

Specifically, the power supply terminal PB and the power ground terminal PGND are disposed at one of the short sides that face each other, and the P terminal is disposed at another one of the short sides.

Positions of each terminal, shapes of internal wiring, etc. are configured so that a direction of the current that flows into the P terminal through the high side MOS transistor 30 from the power supply terminal PB and a direction of the current that flows into the power ground terminal PGND through the low side MOS transistor 31 from the P terminal face each other mutually and become opposite.

In addition, the power supply terminal PB and the power ground terminal PGND may be disposed at one of long sides that face each other, and the P terminal at another one of the long sides.

Thus, the positive electrode side bus bar 302 and the negative electrode side bus bar 303 (to be exact, the terminal base 308 to which these are inserted) are disposed at upper parts of the MOS modules 3AU, and the electric power converter 3 is attached so as to press each upper surface of the MOS modules 3AU.

A heat sink 306 (refer to FIG. 9) that radiates heat occurs in the MOS transistors 30 and 31 is exposed to an bottom surface of each MOS module 3AU.

The bottom surfaces of the MOS modules 3AU are contacted and pressed against the frame 40 and attached thereto.

In order to improve thermal conductivity, it is desirable that grease G1 (refer to FIG. 6) having satisfactory thermal conductivity is filled in gaps formed between the bottom surfaces of the MOS module 3AU and the frame 40.

Moreover, since the positive electrode side bus bar 302 and the negative electrode side bus bar 303 (terminal base 308) are in contact with the upper surfaces of the MOS modules 3AU under a pressed condition, these bus bars can be used also as heat dissipation members that radiate heat generated by the MOS transistors 30 and 31 included in the MOS modules 3AU.

However, in order to improve heat dissipation ability of the bus bars as the heat dissipation member, it is desirable to devise such as to improve thermal conductivity of the MOS modules 3AU and the mold resin that forms the terminal base 308, or to fill grease G2 (refer to FIG. 6) having satisfactory thermal conductivity in gaps formed between the MOS modules 3AU and the terminal base 308.

It should be noted that, in FIG. 6, although filling positions of the greases G1 and G2 corresponding to the MOS module 3BX are shown by hatching, the same applies to other MOS modules 3AU, etc., and thus illustration is omitted.

Moreover, it is not necessary to make at least one of the greases G1 and G2 to be filled correspond to all the MOS modules 3AU, and this may reduce the number of the MOS modules 3AU that become candidates for filling in consideration of the variation in heat dissipation ability.

The frame 40 is for accommodating and supporting the rotor 20 and the stator 2, and as shown in FIG. 5 and FIG. 6, the frame 40 is constituted by three divided parts, namely a rear part 40A, a center part 40B, and a front part 40C.

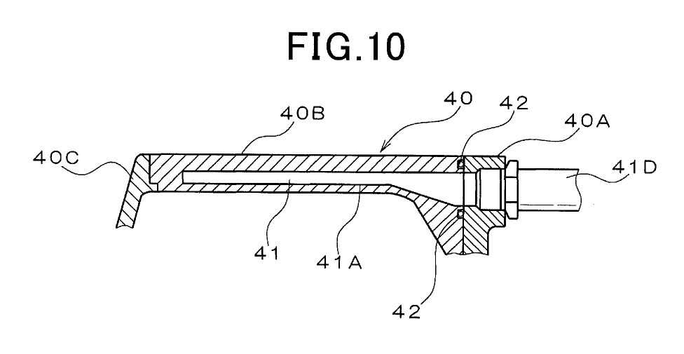

The center part 40B is a cylindrical component that accommodates the stator, and as shown in FIG. 10, a recessed portion 41A that constitutes a cooling fluid channel 41 is provided inside.

The rear part 40A is a disk-like component that closes a rear side (anti-pulley side) that is one of axial ends of the center part 40B.

The cooling fluid channel 41 of the center part 40B opens in one of the axial ends of the center part 40B, and O rings 42 for maintaining airtightness are disposed at both sides of this opening.

Then, the cooling fluid channel 41 is formed by attaching the rear part 40A so as to contact with the O rings 42 and closing the opening of the recessed portion 41A.

Moreover, the electric power converter 3 is attached to the rear part 40A at the axial end opposite to the center part 40B in a condition where the bottom surfaces of the MOS modules 3AU are contacted.

A transverse section of the cooling fluid channel 41 has a C-shape, and a cooling fluid entrance 41B (refer to FIG. 5, FIG. 6) is formed at a part of the rear part 40A corresponding to one end of the C-shape, and a cooling fluid exit 41C (refer to FIG. 5, FIG. 6) is formed at a part of rear part 40A corresponding to another end of the C-shape.

Piping 41D (refer to FIG. 10) for cooling fluid is connected to each of the cooling fluid entrance 41B and the cooling fluid exit 41C, and cooling fluid is supplied and discharged to/from the cooling fluid channel 41.

The frame 40 is cooled by letting the cooling fluid flow through such a cooling fluid channel 41.

Accordingly, in the rotating electric machine 100 for vehicles of the present embodiment, since each terminal, such as the power supply terminal PB, is disposed so that the currents that flow through insides of the MOS modules 3AU are faced to each other in opposite flowing direction, magnetic fields that occur around current pathways that face can be canceled mutually, and inductance of the current pathways inside the MOS modules 3AU can be reduced.

Thereby, surge voltage generated when turning on and off the MOS transistors 30 and 31, and heat generated accompanying the surge voltage can be reduced.

Moreover, the terminal base 308 including the positive electrode side bus bar 302 and the negative electrode side bus bar 303 is attached to a plurality of (six pieces) MOS modules 3AU in a condition where each upper surface thereof is pressed.

Thereby, since it becomes possible to fix each MOS module 3AU by pressing the positive electrode side bus bar 302, the negative electrode side bus bar 303, or the terminal base 308, parts for screw-fixing become unnecessary, and this can reduce mounting spaces by miniaturizing the MOS modules 3AU.

Moreover, the positive electrode side bus bar 302 and the negative electrode side bus bar 303 are formed where the tabular wiring layers are laminated.

Thus, since the magnetic field that occurs due to the currents flowing in opposite flowing direction in each wiring layer can be canceled by laminating the tabular wiring layers having different polarities, inductance of the positive electrode side bus bar 302 and the negative electrode side bus bar 303 can be reduced.

Thereby, surge voltage generated when turning on and off the MOS transistors 30 and 31, and heat generated accompanying the surge voltage can be reduced.

Moreover, the MOS module 3AU has the rectangular shape, the power ground terminal PGND and the power supply terminal PB are disposed in one of the facing two sides, and the P terminal connected to the stator winding is disposed in the other one of the two sides.

Thereby, the pathways where the large current flowing inside the MOS modules 3AU that turn around can be formed, and it becomes possible to cancel mutually the magnetic fields that occur around the current pathways.

Moreover, the frame 40 that accommodates the rotor 20 and the stator is disposed in a side opposite of pressing the MOS modules 3AU, and the bottom surfaces of the MOSs module 3AU contact the frame 40.

Thereby, the coolability of the MOS modules 3AU can be raised by transmitting the heat generated in the MOS modules 3AU to the frame 40.

Moreover, the frame 40 has the cooling fluid channel 41, and is cooled by the cooling fluid that flows through the cooling fluid channel 41.

Thereby, the stable coolability of the MOS modules 3AU can be obtained.

Moreover, the coolability of the MOS modules 3AU can further be raised by using the positive electrode side bus bar 302, the negative electrode side bus bar 303, or the terminal base 308 as the heat dissipation members that radiates heat generated by the MOS transistors 30 and 31 included in the plurality of the MOS modules 3AU.

In addition, the present disclosure is not limited to the embodiment mentioned above, and various modifications can be employed within the limits of the scope of the present disclosure.

For example, although the embodiment mentioned above explains the rotating electric machine 100 for the vehicle that operates as an ISG, the present disclosure is applicable also to a rotating electric machine for a vehicle that performs either electric operation or power generation.

Moreover, although it is configured to provide the two stator windings 1A and 1B and the two MOS module groups 3A and 3B in the embodiment mentioned above, the present disclosure is applicable also to a rotating electric machine provided with a single stator winding 1A and a single rectifier module group 3A, or a rotating electric machine provided with more than three stator windings and MOS modules.

Moreover, although three each of the MOS modules 3AU are distributed and disposed right and left across the center of the positive electrode side input/output terminal 300 and the negative electrode side input/output terminal 301 in the embodiment mentioned above, numbers of the MOS modules 3AU distributed to right and left may be changed, or the MOS modules 3AU may be disposed only in either side.

As mentioned above, according to the present disclosure, since the terminals are disposed so that the currents that flow through insides of the switching modules are faced to each other in opposite flowing direction, the magnetic fields that occur around the current pathways that face can be canceled mutually, and inductance of the current pathways inside the switching modules can be reduced.

Thereby, surge voltage generated when turning on and off the switching modules and heat generated accompanying the occurrence can be reduced.

What is claimed is:

1. A rotating electric machine for vehicles comprising:
a rotor;
a stator disposed facing the rotor; and
an electric power converter that converts alternating current voltage induced by a stator winding included in the stator into direct current voltage, or converts direct current voltage applied from outside into alternating current voltage and applies it to the stator winding; wherein,
the electric power converter includes a plurality of switching modules, each of which includes a first switching element on a high side and a second switching element on a low side;
the switching module has a length and a plurality of terminals which are pulled out from both ends of the switching module;
the plurality of terminals are disposed in positions where currents that flow through insides of the switching modules are faced to each other in opposite flowing directions; and
a bus bar is disposed at an upper surface side of each switching module.

2. The rotating electric machine for vehicles according to claim 1, wherein,
the bus bar is attached to the switching module in a condition where each upper surface of the switching modules is pressed.

3. The rotating electric machine for vehicles according to claim 2, wherein,
the electric power converter has a terminal base to which the bus bar is inserted.

4. The rotating electric machine for vehicles according to claim 3, wherein,
grease is filled in gaps formed between the switching modules and the terminal base.

5. The rotating electric machine for vehicles according to claim 1, wherein,
the bus bar is formed by laminating tabular wiring layers;
the plurality of terminals pulled out from both ends of the switching module are a ground terminal and a power supply terminal; and
the wiring layers are connected to the ground terminal and the power supply terminal.

6. The rotating electric machine for vehicles according to claim 1, wherein,
the switching module has a rectangular shape;
the terminals are disposed in one of two facing sides of the switching module; and
another terminal connected to the stator winding is disposed in another one of the two sides.

7. The rotating electric machine for vehicles according to claim 2, wherein,
a frame that accommodates the rotor and the stator is disposed on the switching module opposite from the side where pressure is being applied from; and
a bottom surface of the switching module contacts the frame.

8. The rotating electric machine for vehicles according to claim 7, wherein,
grease is filled in gaps formed between the switching modules and the frame.

9. The rotating electric machine for vehicles according to claim 7, wherein,
the frame has a cooling fluid channel, and is cooled by a cooling fluid that flows through the cooling fluid channel.

10. The rotating electric machine for vehicles according to claim 1, wherein,
the bus bar is used as a heat dissipation member that radiates heat generated by the first and second switching elements included in the switching modules.
